(19) United States
(12) Patent Application Publication
(10) Pub. No.: US 2003/0031831 A1
(43) Pub. Date: Feb. 13, 2003

(54) Apparatus for use with pizza dough

(76) Inventor: Anthony Donarumia, West Islip, NY (US)

Correspondence Address: Anthony Donarumia, 474 Kime Avenue, West Islip, NY, 11795, US

(21) Appl. No.: 09/923,219

(22) Filed: Aug. 7, 2001

(51) Int. Cl. B32B 3/00

(52) U.S. Cl. 428/156

(57) ABSTRACT

The invention is used in the preparation and storage of dough for the making of non-circular shaped pizzas such as Sicilian pizzas at pizzerias and other restaurant establishments which prepare and sell pizzas.

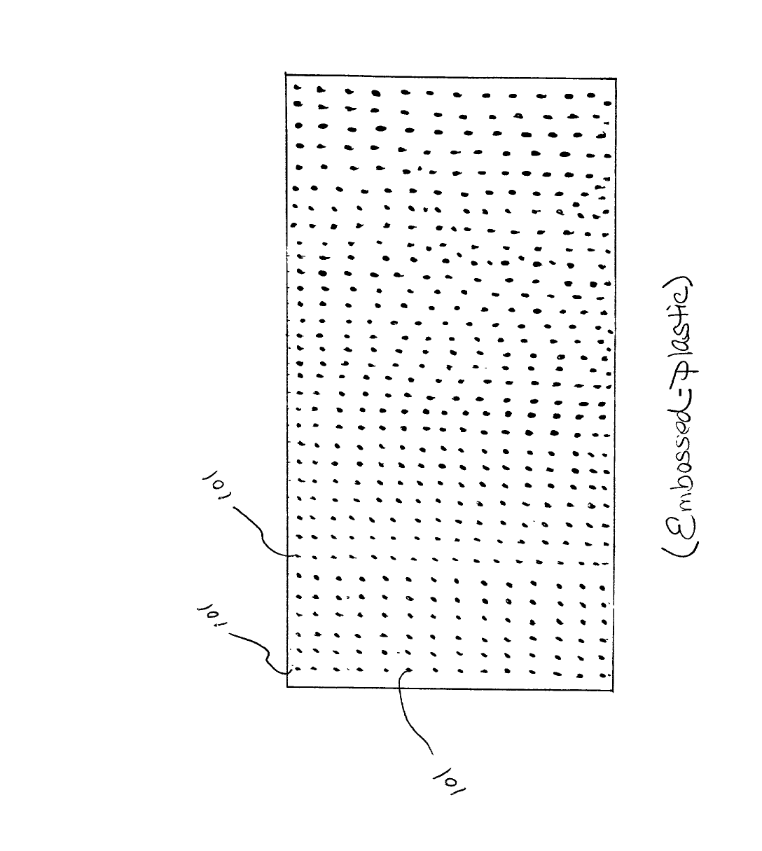

### BACKGROUND OF THE INVENTION

The present invention is directed to the field of preparing and maintaining pizza dough. More specifically the present invention is directed to an apparatus for use in making non-round pizza.

Pizza is a popular food all over the world. Typically a pizza consists of dough, rolled out, and covered by one or more toppings, and baked. Common toppings include cheese, tomato, meat (e.g. sausage, peppers, . . . ) and vegetables (e.g. mushrooms, onions, . . . )

The most common shape for a pizza is circular. Such a pizza is usually cut into wedges to be served as “slices”. However, other shapes of pizza are known as well. One such shape is rectangular. A type of pizza commonly referred to as Sicilian is usually of a rectangular shape.

Usually pizza dough is made and stored for some period in advance of the time that the toppings are added and the combination is baked. Presently there are devices for storing round pieces of dough. When it is time to use the dough for a standard circular pizza it is a simple matter to roll out and twirl out the round piece of dough into a circular shape for what ultimately will become the crust of the pizza. However, when one wishes to make a non-circular pizza it is more troublesome to roll the previously stored dough into the non-circular shape and maintain it in such shape. Thus there is a need for a device to assist the pizza maker in storing and maintaining the dough for non-circular style pizza.

The present invention is intended for use in the preparation of dough for the making of non-circular pizza such as Sicilian style pizzas at pizzerias and other restaurant establishments which prepare and sell pizzas. The invention allows for the storage of freshly made dough in the shape of the pizza to be made so as to maintain the shape, texture and moisture of the dough prior to its eventual use.

### SUMMARY OF THE INVENTION

The present invention is intended to permit pizza makers to prepare non-circular dough and store and maintain such dough in advance of making non-circular style pizzas. One such non-circular style pizza is a Sicilian style pizza which is of a generally rectangular shape.

The drawing figure illustrates an embodiment of the present invention as applied to a Sicilian style pizza.

### BRIEF DESCRIPTION OF THE DRAWING

The drawing figure illustrates an embodiment of the present invention.

### DETAILED DESCRIPTION

In embodiment a plastic sheet, made out of Food and Drug Administration (FDA) approved plastic, has a rectangular shape. The sheet is embossed shown as dots (some of which are numbered 101) on the figure. In one embodiment the sheet has a thickness of approximately 2.5 millimeters and approximately 15 inches by 20 inches in size which corresponds to the dimensions of a typical Sicilian pizza tray.

The embossed plastic sheet keeps the moisture sealed within the dough from the time of the placement of the sheet on top of the dough to the time of the dough's use.

It is intended that the sheet by washable and reusable.

What I claim is:

1. An apparatus for maintaining pizza dough in a non-circular shape comprising: a flat sheet of plastic having a non-circular shape, with no side edges; wherein in said sheet of plastic is embossed so that the embossing portions contact pizza dough when the sheet is placed on same so as to maintain the pizza dough in a shape that closely approximates said non-circular shape of said plastic sheet.

2. The apparatus of claim 1 wherein said non-circular shape of said plastic sheet is approximately rectangular and approximates the dimensions of the prepared rectangular dough.
